(19) United States
(12) Patent Application Publication
(10) Pub. No.: US 2016/0025180 A1
(43) Pub. Date: Jan. 28, 2016

(54) SHOCK ABSORBER

(71) Applicant: KAYABA INDUSTRY CO., LTD., Tokyo (JP)

(72) Inventors: Masaru FUKUSHIMA, Gifu (JP); Toshiharu KAWABE, Gifu (JP)

(73) Assignee: KAYABA INDUSTRY CO., LTD., Tokyo (JP)

(21) Appl. No.: 14/773,991

(22) PCT Filed: Mar. 24, 2014
(86) PCT No.: PCT/JP2014/057992

§ 371 Date: Sep. 9, 2015

(30) Foreign Application Priority Data
Mar. 27, 2013 (JP) 2013-065546

(51) Int. Cl. F16F 9/348; F16F 9/512

(52) U.S. Cl. CPC F16F 9/3488; F16F 9/5126

(57) ABSTRACT

A shock absorber includes expanding-side and contracting-side chambers formed in a cylinder, a housing that forms a pressurizing chamber, a free piston that partitions the pressurizing chamber into an expansive pressurizing chamber communicating with the expanding-side chamber and a contractive pressurizing chamber communicating with the contracting-side chamber, and expanding-side and contracting-side springs that exert biasing forces for suppressing the free piston from being displaced from a neutral position. The contracting-side spring has a non-linear characteristic by which the spring constant increases as it is compressed.

### TECHNICAL FIELD

The present invention relates to improvement of a shock absorber.

### BACKGROUND ART

In JP 2008-215459 A, there is discussed a shock absorber including a cylinder, a piston slidably inserted into the cylinder to partition the cylinder into an expanding-side chamber and a contracting-side chamber, a damping passage that causes the expanding-side chamber and the contracting-side chamber provided in the piston to communicate with each other, a housing provided in a leading end of the piston rod to form a pressurizing chamber, a free piston slidably inserted into the pressurizing chamber to partition the pressurizing chamber into an expansive pressurizing chamber and a contractive pressurizing chamber, a coil spring that biases the free piston, an expanding-side passage that causes the expanding-side chamber and the expansive pressurizing chamber to communicate with each other, and a contracting-side passage that causes the contracting-side chamber and the contractive pressurizing chamber to communicate with each other.

In this shock absorber, the expanding-side chamber and the contracting-side chamber do not directly communicate with each other. However, as the free piston moves, a volume ratio between the expanding-side chamber and the contracting-side chamber changes, so that a liquid inside the pressurizing chamber accesses the expanding-side chamber and the contracting-side chamber depending on the movement amount of the free piston. For this reason, the expanding-side chamber and the contracting-side chamber of the shock absorber appear to communicate with each other.

Such a shock absorber generates a strong damping force for a low frequency vibration input, and generates a weak damping force for a high frequency vibration input. The shock absorber generates a strong damping force when the input vibration frequency is low, for example, when a vehicle turns. Meanwhile, the shock absorber generates a weak damping force when the input vibration frequency is high, for example, when a vehicle travels on an uneven road surface. As a result, the shock absorber can improve ride quality of a vehicle.

### SUMMARY OF INVENTION

In the shock absorber discussed in JP 2008-215459 A, a step portion is provided in the inner circumference of the housing. When the free piston is displaced downward so as to compress the contractive pressurizing chamber and reaches its movement limitation, the lower end of the free piston collides with the step portion, so that the displacement of the free piston is restricted. As the free piston is displaced upwards so as to compress the expansive pressurizing chamber and reaches its movement limitation, the upper end of the free piston collides with the upper end of the housing, so that the displacement of the free piston is restricted.

For example, when a large amplitude vibration is input, the displacement of the free piston is restricted, and no liquid passes through the pressurizing chamber. As a result, the shock absorber can exert a strong damping force to suppress full expansion or full contraction.

Meanwhile, a clunking sound is generated when the free piston collides with the step portion of the housing. This clunking sound may be transmitted through a vehicle chassis and may be echoed inside the cabin, so that a passenger may feel uncomfortable or unstable, and ride quality of a vehicle may be degraded.

In view of the aforementioned problems, it is therefore an object of this invention to provide a shock absorber capable of suppressing generation of a clunking sound and improving ride quality of a vehicle.

According to one aspect of the present invention, a shock absorber includes: a cylinder; a piston slidably inserted into the cylinder to partition the cylinder into an expanding-side chamber and a contracting-side chamber; a damping passage that communicates the expanding-side chamber to the contracting-side chamber; a housing that forms a pressurizing chamber; a free piston slidably inserted into the pressurizing chamber to partition the pressurizing chamber into an expansive pressurizing chamber and a contractive pressurizing chamber; an expanding-side passage that communicates the expanding-side chamber to the expansive pressurizing chamber; a contracting-side passage that communicates the contracting-side chamber to the contractive pressurizing chamber; and a spring element being configured to position the free piston in a neutral position with respect to the housing, the spring element being configured to exert a biasing force for suppressing the free piston from being displaced from the neutral position. The spring element has an expanding-side spring housed in the expansive pressurizing chamber and a contracting-side spring housed in the contractive pressurizing chamber to interpose the free piston. The contracting-side spring has a non-linear characteristic by which a spring constant increases as it is compressed.

### BRIEF DESCRIPTION OF DRAWINGS

FIG. 1 is a cross-sectional view illustrating a shock absorber according to an embodiment of this invention;

FIG. 2A is a cross-sectional view illustrating a conical coil spring used as a spring element; and

FIG. 2B is a cross-sectional view illustrating a tapered coil spring used as a spring element.

### DESCRIPTION OF EMBODIMENTS

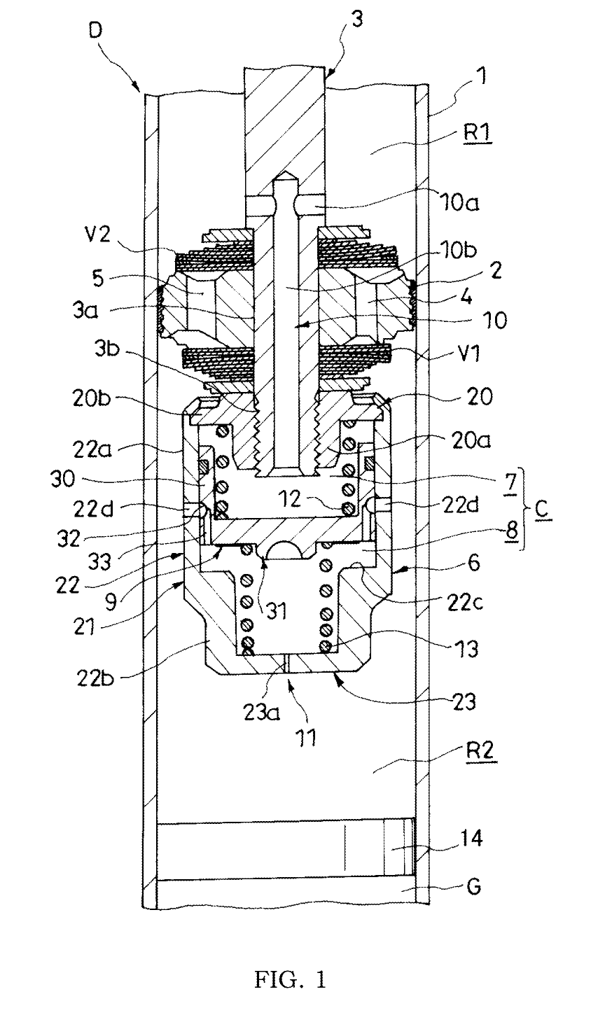

A description will now be made for a shock absorber according to an embodiment of this invention with reference to FIG. 1.

Referring to FIG. 1, a shock absorber D comprises a cylinder 1, a piston 2 slidably inserted into the cylinder 1 to partition the cylinder 1 into an expanding-side chamber R1 and a contracting-side chamber R2, damping passages 4 and 5 that cause the expanding-side chamber R1 and the contracting-side chamber R2 to communicate with each other, a housing 6 that forms a pressurizing chamber C, a free piston 9 slidably inserted into the housing 6 to partition the pressurizing chamber C into an expansive pressurizing chamber 7 and a contractive pressurizing chamber 8, an expanding-side passage 10 that causes the expanding-side chamber R1 and the expansive pressurizing chamber 7 to communicate with each other, a contracting-side passage 11 that causes the contracting-side chamber R2 and the contractive pressurizing chamber 8 to communicate with each other, and expanding-side and contracting-side springs 12 and 13 as a spring element for exerting a biasing force to the free piston 9.

The shock absorber D further comprises a piston rod 3 movably inserted into the cylinder 1. One end of the piston rod 3 is connected to the piston 2, and the other end as an upper end is slidably and axially supported by an annular rod guide (not shown) that seals the upper end of the cylinder 1. The lower end of the cylinder 1 is sealed with a bottom member (not shown).

A liquid such as hydraulic oil is filled in the expanding-side chamber R1, the contracting-side chamber R2, and the pressurizing chamber C. A sliding partition 14 that makes sliding contact with the inner circumference of the cylinder 1 to partition the cylinder 1 into the contracting-side chamber R2 and the gas chamber G is provided under the cylinder 1 of FIG. 1. The liquid filled in the expanding-side chamber R1, the contracting-side chamber R2, and the pressurizing chamber C may also include, for example, water, an aqueous solution, and the like other than the hydraulic oil.

The shock absorber D is a single-rod type shock absorber in which the piston rod 3 is inserted only to the expanding-side chamber R1. For this reason, a volume of the piston rod 3 inserted to or extracted from the cylinder 1 as the shock absorber D expands or contracts is compensated by movement of the sliding partition 14 in a vertical direction of FIG. 1 caused by expansion or contraction of the gas volume inside the gas chamber G. In order to compensate for the volume caused by the piston rod 3 inserted into or extracted from the cylinder 1, a reservoir may be provided inside or outside the cylinder 1 in addition to or instead of the gas chamber G provided in the cylinder 1. When the reservoir is provided outside the cylinder 1, an outer tube that covers the outer circumference of the cylinder 1 may be provided so as to form a reservoir between the cylinder 1 and the outer tube and serve as a twin-tube type shock absorber. In addition, a tank separate from the cylinder 1 may be provided to form the reservoir. When the reservoir is provided, a partition member that partitions the inside into the contracting-side chamber R2 and the reservoir in order to increase a pressure of the contracting-side chamber R2 in a contracting operation of the shock absorber D and a base valve provided in the partition member to apply resistance to the liquid flowing from the contracting-side chamber R2 to the reservoir may be further provided. In addition, the shock absorber D may be a dual-rod type instead of the single-rod type.

Next, a description will be made for each part of the shock absorber D in more detail.

The piston 2 is connected to one end 3a, that is the lower end of FIG. 1, of the piston rod 3 movably inserted into the cylinder 1. The other end of the piston rod 3 protrudes outward through the inner circumference of an annular rod guide (not shown) fixed to the upper end of the cylinder 1 in FIG. 1. Since a gap between the piston rod 3 and the rod guide is sealed with a seal member (not shown), the cylinder 1 is internally encapsulated in a liquid-tight manner.

The piston 2 is provided with a pair of damping passages 4 and 5 that cause the expanding-side chamber R1 and the contracting-side chamber R2 to communicate with each other. The lower end of one of the damping passages 4 in FIG. 1 is opened or closed by a leaf valve V1 underlying the piston 2 in FIG. 1. The upper end of the other damping passage 5 in FIG. 1 is opened or closed by a leaf valve V2 overlying the piston 2 in FIG. 1.

The leaf valve V1 has an annular shape and is mounted to one end 3a of the piston rod 3 together with the piston 2. The leaf valve V1 is flexed as the liquid flows from the expanding-side chamber R1 to the contracting-side chamber R2 through the damping passage 4 during the expansion process of the shock absorber D, in which the piston 2 moves upward in FIG. 1, so as to open the damping passage 4 and apply resistance to the liquid flow. The damping passage 4 is closed during the contraction process of the shock absorber D. That is, the leaf valve V1 makes the damping passage 4 serve as a one-way passage that allows only for a flow directed from the expanding-side chamber R1 to the contracting-side chamber R2.

The leaf valve V2 has an annular shape and is mounted to one end 3a of the piston rod 3 together with the piston 2. The leaf valve V2 is flexed as the liquid flows from the contracting-side chamber R2 to the expanding-side chamber R1 through the damping passage 5 during the contraction process of the shock absorber D, in which the piston 2 moves downward in FIG. 1, so as to open the damping passage 5 and apply resistance to the liquid flow. The damping passage 5 is closed during the expansion process of the shock absorber D. That is, the leaf valve V2 makes the damping passage 5 serve as a one-way passage that allows only for a flow directed from the contracting-side chamber R2 to the expanding-side chamber R1.

That is, the leaf valve V1 serves as an expansion-side damping valve for applying resistance to the liquid flowing through the damping passage 4 during the expansion process, whereas the leaf valve V2 serves as a contraction-side damping valve for applying resistance to the liquid flowing through the damping passage 5 during the contraction process.

If a plurality of the damping passages 4 and 5 are provided in this manner, the damping passages may be configured as one-way passages such that the liquid flows only in the expansion or contraction process. Alternatively, the damping passages may be configured to allow for a bidirectional flow and apply resistance to the liquid flow passing therethrough. In order to apply resistance to the liquid flow passing through the damping passages, various damping valves such as a poppet valve, an orifice, and a chalk may also be employed instead of the leaf valve described above. It is noted that the damping passages 4 and 5 may also be provided in positions other than the piston 2.

The pressurizing chamber C is formed by the housing 6 as a cavity screwed to a thread portion 3b provided in the outer circumference of the leading edge of the one end 3a of the piston rod 3. The housing 6 also serves as a piston nut for fixing the piston 2 and the leaf valves V1 and V2 to the one end 3a of the piston rod 3.

The pressurizing chamber C formed in the housing 6 is partitioned by the free piston 9 slidably inserted to the pressurizing chamber C into an expansive pressurizing chamber 7 in the upper half of FIG. 1 and a contractive pressurizing chamber 8 in the lower half of FIG. 1. The free piston 9 may be displaced in a vertical direction of FIG. 1 with respect to the housing 6 inside the pressurizing chamber C.

The housing 6 is provided with a nut portion 20 screwed to the thread portion 3b formed in the one end 3a of the piston rod 3 and a bottomed cylindrical housing cylinder 21 fixed to the nut portion 20.

The inner circumference of the nut portion 20 is provided with a threaded tube 20a screwed to the thread portion 3b of the piston rod 3 and a brim 20b that is provided in the outer circumference of the threaded tube 20a to protrude outward.

The housing cylinder 21 has a tubular portion 22 having an upper end opening caulked to the outer circumference of the brim 20b and a bottom portion 23 that closes the lower end of the tubular portion 22. The tubular portion 22 has a large inner-diameter portion 22a that is formed in the nut portion side and makes sliding contact with the free piston 9, a small inner-diameter portion 22b formed oppositely to the nut portion side, and a step portion 22c provided between the large inner-diameter portion 22a and the small inner-diameter portion 22b. The integration between the nut portion 20 and the housing cylinder 21 may be performed through other fabrication methods such as welding or screwing instead of the caulking.

The outer circumference in at least a part of the tubular portion 22 of the housing cylinder 21 has a non-circular cross-sectional shape for facilitating gripping of a tool (not shown). Such a shape may include any shape matching the tool, such as a partially notched shape or a hexagonal shape. It is possible to screw the housing 6 to thread portion 3b by gripping the outer circumference of the tubular portion 22 with a tool and rotating the housing 6 in a circumferential direction.

An orifice 22d is provided in the lateral side of the tubular portion 22, and an orifice 23a is provided in the bottom portion 23. The orifices 22d and 23a cause the pressurizing chamber C and the contracting-side chamber R2 to communicate with each other.

The expansive pressurizing chamber 7 communicates with the expanding-side chamber R1 through the expanding-side passage 10 provided in the piston rod 3. The expanding-side passage 10 includes a longitudinal hole 10a opened to the lateral side of the piston rod 3 facing the expanding-side chamber R1 and a transverse hole 10b opened to a tip portion of the one end 3a to communicate with the longitudinal hole 10a.

The free piston 9 inserted to the pressurizing chamber C is a bottomed cylindrical member having a sliding contact tube 30 making sliding contact with the inner circumferential surface of the large inner-diameter portion 22a of the housing cylinder 21, and a bottom portion 31 that closes the lower end of the sliding contact tube 30. The free piston 9 further has an annular recess 32 formed across the entire outer circumference of the sliding contact tube 30 and a communicating hole 33 that causes the annular recess 32 to communicate with the contractive pressurizing chamber 8. When the annular recess 32 faces the orifice 22d formed in the tubular portion 22 of the housing 6, the contracting-side chamber R2 communicates with the contractive pressurizing chamber 8 through the orifice 22d. When the annular recess 32 does not face the orifice 22d, and the orifice 22d is closed by the sliding contact tube 30, the contracting-side chamber R2 and the contractive pressurizing chamber 8 do not communicate with each other through the orifice 22d.

The orifice 22d applies resistance to the flow of the passing liquid to generate a predetermined pressure loss and a pressure difference between the contracting-side chamber R2 and the contractive pressurizing chamber 8. Similar to the orifice 22d, the orifice 23a provided in the bottom portion 23 of the housing cylinder 21 also serves as an aperture passage to generate a pressure difference between the contracting-side chamber R2 and the contractive pressurizing chamber 8. It is noted that the orifice 23a provided in the bottom portion 23 is not closed by the free piston 9 and is opened at all times. That is, when the orifice 22d is opened, the contractive pressurizing chamber 8 communicates with the contracting-side chamber R2 through a pair of orifices 22d and 23a. When the orifice 22d is closed, the contractive pressurizing chamber 8 communicates with the contracting-side chamber R2 only through the orifice 23a. The contracting-side passage 11 that causes the contracting-side chamber R2 and the contractive pressurizing chamber 8 to communicate with each other includes the orifices 22d and 23a, the annular recess 32, and the communicating hole 33.

A spring element is provided in the housing 6 in order to suppress displacement of the free piston 9 with respect to the housing 6. The spring element includes an expanding-side spring 12 provided in the expansive pressurizing chamber 7 and interposed between the brim 20b of the nut portion 20 and the bottom portion 31 of the free piston 9 in a compressed state and a contracting-side spring 13 provided in the contractive pressurizing chamber 8 and interposed between the bottom portion 23 and the bottom portion 31 of the free piston 9 in a compressed state.

The free piston 9 is interposed vertically between the expanding-side spring 12 and the contracting-side spring 13 so as to be positioned in a predetermined neutral position inside the pressurizing chamber C. As the free piston 9 is displaced from the neutral position, the expanding-side spring 12 and the contracting-side spring 13 exert a biasing force for returning the free piston 9 to the neutral position. The neutral position does not refer to a center of the pressurizing chamber C in the axial direction, but refers to a position of the free piston 9 determined by the spring element.

The expanding-side spring 12 is a variable pitch coil spring. While the free piston 9 is displaced from the neutral position to compress the expansive pressurizing chamber 7 and reach to the stroke end, first, coils of a narrow pitch side of the expanding-side spring 12 approach and abut on each other, and subsequently, coils of a wide pitch side are compressed. In this manner, the expanding-side spring 12 has a non-linear characteristic by which a spring constant increases as it is compressed. That is, as the displacement amount of the free piston 9 increases, the spring constant of the expanding-side spring 12 also gradually increases, and the reactive force of the expanding-side spring 12 becomes strong, so that the displacement of the free piston 9 is suppressed.

Similar to the expanding-side spring 12, the contracting-side spring 13 is also a variable pitch coil spring. While the free piston 9 is displaced from the neutral position to compress the contractive pressurizing chamber 8 and reach to the stroke end, first, the coils of a narrow pitch side of the contracting-side spring 13 approach and abut on each other, and subsequently, the coils of a wide pitch side are compressed. In this manner, the contracting-side spring 13 has a non-linear characteristic by which a spring constant increases as it is compressed. That is, as the displacement amount of the free piston 9 increases, the spring constant of the contracting-side spring 13 also gradually increases, and the reactive force of the contracting-side spring 13 becomes strong, so that the displacement of the free piston 9 is suppressed.

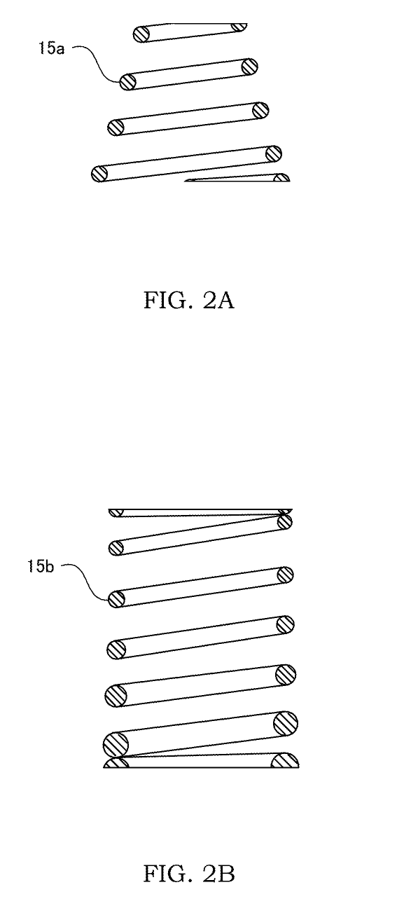

Any spring element may be employed for the expanding-side spring 12 and the contracting-side spring 13 if its spring constant increases as the displacement amount of the free piston 9 increases. For example, a conical coil spring 15a of which spring constant gradually increases as it is compressed as illustrated in FIG. 2A may be employed. Alternatively, a tapered coil spring 15b of which spring constant increases as it is compressed by a predetermined amount by changing the coil diameter as illustrated in FIG. 2B may be employed. In addition, the expanding-side spring 12 and the contracting-side spring 13 may include a spring having a long natural length and making contact with the free piston 9 at all times and a spring having a short natural length and making contact with the free piston 9 to exert the spring reaction force as the free piston 9 is displaced by a predetermined amount from the neutral position.

As described above, the free piston 9 is elastically supported by the expanding-side spring 12 and the contracting-side spring 13 as a spring element inside the housing 6. While no force is exerted to the free piston 9 except for the biasing forces of the expanding-side spring 12 and the contracting-side spring 13, the free piston 9 is in the neutral position inside the housing 6. When the free piston 9 is in the neutral position, the annular recess 32 faces the orifice 22d so that the contractive pressurizing chamber 8 and the contracting-side chamber R2 communicate with each other through the orifice 22d. As the free piston 9 is displaced by a predetermined amount from the neutral position, the outer circumference of the sliding contact tube 30 of the free piston 9 perfectly closes the orifice 22d. The displacement amount from the neutral position for starting the free piston 9 to close the orifice 22d may be set arbitrarily. The displacement amount of the free piston 9 from the neutral position to the expansive pressurizing chamber 7 side, that is, upward in FIG. 1 for starting to close the orifice 22d may be set to be different from the displacement amount of the free piston 9 from the neutral position to the contractive pressurizing chamber 8 side, that is, downward in FIG. 1 for starting to close the orifice 22d. Although a pair of orifices 22d are provided in this embodiment, the number of the orifices 22d may be set to any other number. In addition, an annular recess may be provided in the inner circumference of the tubular portion 22, and an orifice for causing the outer circumferential side of the free piston 9 and the contractive pressurizing chamber 8 to communicate with each other may be provided in the free piston 9.

In the shock absorber D configured as described above, as the free piston 9 moves, a volume ratio between the expanding-side chamber R1 and the contracting-side chamber R2 changes, so that the liquid inside the pressurizing chamber C accesses the expanding-side chamber R1 and the contracting-side chamber R2 depending on the movement amount of the free piston 9. For this reason, the shock absorber appears to behave such that the expanding-side chamber R1 and the contracting-side chamber R2 communicate with each other.

Here, assuming that “P” denotes a differential pressure between the expanding-side chamber R1 and the contracting-side chamber R2 during expansion or contraction of the shock absorber, “Q” denotes a flow rate of the liquid flowing from the expanding-side chamber R1, “C1” denotes a coefficient representing a relationship between the differential pressure P and the flow rate Q1 of the liquid passing through the damping passages 4 and 5, “P1” denotes a pressure of the expansive pressurizing chamber 7, “C2” denotes a coefficient representing a relationship between a difference between the differential pressure P and the pressure P1 and a flow rate Q2 of the liquid flowing to the expansive pressurizing chamber 7 from the expanding-side chamber R1, “P2” denotes a pressure of the contractive pressurizing chamber 8, “C3” denotes a coefficient representing a relationship between the pressure P2 and the flow rate Q2 of the liquid flowing to the contracting-side chamber R2 from the contractive pressurizing chamber 8, “A” denotes a pressure-receiving cross-sectional area of the free piston 9, “X” denotes a displacement of the free piston 9 with respect to the pressurizing chamber C, “K” denotes a spring constant of the spring element, that is, a synthetic spring constant of the expanding-side spring 12 and the contracting-side spring 13, and “s” denotes a Laplace operator, a transfer function of the differential pressure P against the flow rate Q can be obtained as follows.

$$\begin{matrix}[ Equation 1 ] & \\ G ( s ) = \frac{P ( s )}{Q ( s )} = \frac{C 1 \{ 1 + {A}^{2} ( C 2 + C 3 ) s / K \}}{1 + {A}^{2} ( C 1 + C 2 + C 3 ) s / K} & ( 1 )\end{matrix}$$

By substituting the Laplace operator “s” of the transfer function of Equation 1 with “jΩ,” an absolute value of the frequency transfer function “G(jω)” can be obtained as follows.

$$\begin{matrix}[ Equation 2 ] & \\ \vert G ( j ω ) \vert = \frac{C {1 [ \begin{matrix}{K}^{4} + {K}^{2} {A}^{4} \{ 2 ( C 2 + C 3 ) ( C 1 + C 2 + C 3 ) + C {1}^{2} \} \\ {ω}^{2} + {{A}^{8} ( C 2 + C 3 )}^{2} {( C 1 + C 2 + C 3 )}^{2} {ω}^{4}\end{matrix} ]}^{1 / 2}}{{K}^{2} + {{A}^{4} ( C 1 + C 2 + C 3 )}^{2} {ω}^{2}} & ( 2 )\end{matrix}$$

As recognized from each of the aforementioned equations, a frequency characteristic of the transfer function of the differential pressure P against the flow rate Q in the shock absorber D1 has two break point frequencies, “Fₐ=K/{2πA²(C1+C2+C3)}” and “F_{b}=K/{2πA²(C2+C3)}.” In addition, a gain of the transfer function is approximated to “C1” within a range of F<Fₐ, gradually decreases from “C1” to “C1(C2+C3)/(C1+C2+C3)” within a range of Fₐ≦F≦F_{b}, and becomes constant within a range of F>F_{b}. That is, a frequency characteristic of the transfer function of the differential pressure P against the flow rate Q changes such that the gain of the transfer function increases in a low frequency range, and decreases in a high frequency range.

According to the embodiment described above, it is possible to obtain the following effects.

In the shock absorber D1 according to this embodiment, a strong damping force can be generated for a low frequency vibration input, whereas a weak damping force can be generated for a high frequency vibration input by virtue of the damping force reduction effect. For this reason, a strong damping force is generated when the input vibration frequency is low, for example, when a vehicle turns. Meanwhile, a weak damping force is generated when the input vibration frequency is high, for example, when a vehicle travels on an uneven road surface. Therefore, it is possible to improve ride quality of a vehicle.

If the free piston 9 is displaced from the neutral position to close the orifice 22d, a flow resistance of the contracting-side passage 11 gradually increases until the orifice 22d is perfectly closed after the start of the closing operation. For this reason, a movement velocity of the free piston 9 to the stroke end decreases, and an apparent movement amount of the liquid passing through the pressurizing chamber C between the expanding-side chamber R1 and the contracting-side chamber R2 also decreases. As the apparent movement amount of the liquid decreases, the amount of the liquid passing through the damping passages 4 and 5 increases accordingly. Therefore, the damping force generated in the shock absorber D1 gradually increases regardless of whether the vibration frequency is high or low. In this manner, it is possible to gradually increase the damping force of the shock absorber Dl. Therefore, it is possible to prevent the shock absorber D1 from abruptly changing from a low damping force state to a high damping force state when a high frequency vibration is input. Accordingly, it is possible to prevent a passenger from feeling a shock caused by a change of the damping force. It is noted that, although the flow path area of the contracting-side passage 11 is reduced so that a flow resistance gradually increases depending on the displacement of the free piston 9 according to this embodiment, it is possible to obtain the same effects by setting the flow resistance of the expanding-side passage 10 to increase in addition or instead.

If the shock absorber D1 receives a large amplitude vibration in the contracting direction, and the free piston 9 is displaced from the neutral position to the expansive pressurizing chamber side over a predetermined displacement amount, the spring constant of the expanding-side spring 12 gradually increases, and the biasing force exerted to the free piston 9 also increases. For this reason, the displacement of the free piston 9 toward the expansive pressurizing chamber side is suppressed, so that a displacement velocity of the free piston 9 toward the expansive pressurizing chamber side is lowered. As a result, it is possible to suppress the free piston 9 from strongly colliding with the housing 6 and thus prevent generation of a clunking sound.

If the shock absorber D1 receives a large amplitude vibration in the expanding direction, and the free piston 9 is displaced from the neutral position to the contractive pressurizing chamber side over a predetermined displacement amount, the spring constant of the contracting-side spring 13 gradually increases, and the biasing force exerted to the free piston 9 also increases. For this reason, the displacement of the free piston 9 toward the contractive pressurizing chamber side is suppressed, so that a displacement velocity of the free piston 9 toward the contractive pressurizing chamber side is lowered. As a result, it is possible to suppress the free piston 9 from strongly colliding with the housing 6 and thus prevent generation of a clunking sound.

In this manner, in the shock absorber D according to this embodiment, by providing the expanding-side spring 12 and the contracting-side spring 13 having spring constants set to increase as they are compressed , it is possible to prevent generation of a clunking sound. For this reason, it is possible to prevent a vehicle passenger from feeling unstable or uncomfortable and improve ride quality of a vehicle.

It is noted that the shock absorber D assembled to a vehicle suspension is generally tuned to generate an expansive damping force stronger than a contractive damping force. Therefore, the expanding-side chamber R1 tends to have a pressure higher than that of the contracting-side chamber R2 so that the free piston 9 is easily biased to the contractive pressurizing chamber 8 side. For this reason, the free piston 9 is more frequently displaced to compress the contractive pressurizing chamber 8 and collide with the housing 6. Meanwhile, the free piston 9 is less frequently displaced to compress the expansive pressurizing chamber 7 and collide with the housing 6. For this reason, it is possible to suppress generation of a clunking sound even by setting the spring constant of only the contracting-side spring 13 to increase as it is compressed.

Embodiments of the present invention were described above, but the above embodiments are merely examples of applications of the present invention, and the technical scope of the present invention is not limited to the specific constitutions of the above embodiments.

This application claims priority based on Japanese Patent Application No. 2013-65546 filed with the Japan Patent Office on Mar. 27, 2013, the entire contents of which are incorporated into this specification.

1. A shock absorber comprising:
a cylinder;
a piston slidably inserted into the cylinder to partition the cylinder into an expanding-side chamber and a contracting-side chamber;
a damping passage that communicates the expanding-side chamber to the contracting-side chamber;
a housing that forms a pressurizing chamber;
a free piston slidably inserted into the pressurizing chamber to partition the pressurizing chamber into an expansive pressurizing chamber and a contractive pressurizing chamber;
an expanding-side passage that communicates the expanding-side chamber to the expansive pressurizing chamber;
a contracting-side passage that communicates the contracting-side chamber to the contractive pressurizing chamber; and
a spring element being configured to position the free piston in a neutral position with respect to the housing, the spring element being configured to exert a biasing force for suppressing the free piston from being displaced from the neutral position,
wherein the contracting-side passage has an orifice formed to penetrate through the housing and a recess formed in an outer circumference of the free piston, the recess communicating with the contractive pressurizing chamber,
the spring element has an expanding-side spring housed in the expansive pressurizing chamber and a contracting-side spring housed in the contractive pressurizing chamber to interpose the free piston,
a flow path area of the contracting-side passage is maximized when the free piston is in the neutral position, and the recess is positioned to face the orifice,
the flow path area of the contracting-side passage is minimized when the free piston is displaced from the neutral position to compress the contractive pressurizing chamber by a predetermined displacement amount, and the recess is positioned not to face the orifice, and
the contracting-side spring has a non-linear characteristic by which a spring constant increases as it is compressed when the free piston is displaced from the neutral position to compress the contractive pressurizing chamber over the predetermined displacement amount.

2. The shock absorber according to claim 1, wherein the expanding-side spring has a non-linear characteristic by which the spring constant increases as it is compressed.

3. The shock absorber according to claim 1, wherein the contracting-side spring is a variable pitch coil spring, a conical coil spring, or a tapered coil spring.

4. The shock absorber according to claim 1, wherein the expanding-side spring is a variable pitch coil spring, a conical coil spring, or a tapered coil spring.

5. The shock absorber according to claim 1, wherein any one or both of the expanding-side spring and the contracting-side spring include(s) a spring having a long natural length and making contact with the free piston at all times, and a spring having a short natural length and making contact with the free piston to exert a spring reaction force when the free piston is displaced from the neutral position by a predetermined amount.
